(19) United States
(12) Patent Application Publication
(10) Pub. No.: US 2025/0173431 A1
(43) Pub. Date: May 29, 2025

(54) SYSTEMS AND METHODS FOR DETECTING MALICIOUS ACTIVITY WITH A FOUNDATIONAL LANGUAGE MODEL

(71) Applicant: Acronis Intemational GmbH, Schaffhausen (CH)

(72) Inventors: Dinil Mon Divakaran, Singapore (SG); Philipp Gysel, Bern (CH); Candid Wüest, Bassersdorf (CH); Serg Bell, Costa Del Sol (SG); Stanislav Protasov, Singapore (SG)

(21) Appl. No.: 18/522,456

(22) Filed: Nov. 29, 2023

(51) Int. Cl. G06F 21/55

(52) U.S. Cl. CPC G06F 21/554; G06F 21/552

(57) ABSTRACT

Disclosed herein are systems and method for detecting malicious activity. A method may receive a plurality of logs indicative of software behavior from an endpoint device and generate, based on the plurality of logs, a provenance graph that represents relationships between different types of data objects on the endpoint device. The method may detect a plurality of trigger actions in the provenance graph and generate, for each respective trigger action of the plurality of trigger actions, a sequence of events that contributed to an occurrence of the respective trigger action. The method may train, using sequences of events generated for the plurality of trigger actions, a foundational language model to predict resultant events for a sequence of lead up events and classify whether the resultant events indicate malicious activity. The method may detect the malicious activity by applying the foundational language model on an input sequence of events.

### FIELD OF TECHNOLOGY

The present disclosure relates to the field of data security, and, more specifically, to systems and methods for detecting malicious activity with a foundational language model.

### BACKGROUND

End-point logs, including system logs, process logs, behavior logs, etc., are crucial in detecting causes of system failures, anomalies, malware infections, insider threats, investigations, etc. Many existing solutions implement rules for such purposes that use these logs. Although fast and precise, rules are limited and focused on detecting only known patterns (e.g., known attack vector of a malware). However, with a rapid evolution of applications, threats, and attacks, and with new malwares being developed for different applications every day, there exists a need for an intelligent system that automatically learns from data and detects such behaviors of interest with minimal human intervention.

### SUMMARY

In one exemplary aspect, the techniques described herein relate to a method for detecting malicious activity using a foundational language model, the method including: receiving a plurality of logs indicative of software behavior from an endpoint device; generating, based on the plurality of logs, a provenance graph that represents relationships between different types of data objects on the endpoint device by linking a plurality of data objects by a plurality of actions; detecting a plurality of trigger actions in the provenance graph; generating, for each respective trigger action of the plurality of trigger actions, a sequence of events that contributed to an occurrence of the respective trigger action based on the provenance graph; training, using sequences of events generated for the plurality of trigger actions, a foundational language model to predict resultant events for a sequence of lead up events and classify whether the resultant events indicate malicious activity; and detecting the malicious activity by applying the foundational language model on an input sequence of events.

In some aspects, the techniques described herein relate to a method, wherein each respective sequence of the sequences of events includes a first plurality of lead up events and a second plurality of resultant events, and wherein training the foundational language model includes: masking, for each respective sequence of the sequences of events, the second plurality of resultant events; and adjusting parameters of the foundational language model to output the second plurality of resultant events for an input including the first plurality of lead up events.

In some aspects, the techniques described herein relate to a method, wherein generating the provenance graph includes: identifying, in a first log, a source object, an action performed by the source object, and a target object on which the action was performed; and linking, on the provenance graph, a first identifier of the source object, a second identifier of the action, and a third identifier of the target object.

In some aspects, the techniques described herein relate to a method, wherein generating the provenance graph includes: identifying, in a second log, the target object, another action performed by the target object, and a different target object on which the another action was performed; and linking, on the provenance graph, the first identifier of the source object, the second identifier of the action, the third identifier of the target object, a fourth identifier of the another action, and a fifth identifier of the different target object.

In some aspects, the techniques described herein relate to a method, wherein the sequences of events include ordered events capturing one or more of: (a) a process initiating or terminating, (b) a file or directory being created, modified, deleted, or read, (c) a network connection being established, modified, or terminated, (d) a registry file being accessed.

In some aspects, the techniques described herein relate to a method, wherein the plurality of trigger actions is indicative of malicious activity.

In some aspects, the techniques described herein relate to a method, wherein the plurality of trigger actions include one or more of: (a) a malicious file being detected, downloaded, or executed, (b) sensitive data being accessed, (c) an executable being started from a temporary folder location, (d) a DNS lookup is performed for a suspicious domain, (e) a PowerShell script being started with obfuscated parameters, (f) persistence being created via a registry key or via a startup folder, and (g) an upload size greater than a threshold data amount being performed.

In some aspects, the techniques described herein relate to a method, wherein receiving the plurality of logs includes: monitoring processes on the endpoint device using an agent locally installed on the endpoint device.

In some aspects, the techniques described herein relate to a method, wherein monitoring the processes includes tracking kernel API calls and/or operating system calls.

In some aspects, the techniques described herein relate to a method, further including: removing personal identifiable information (PII) from the logs to maintain privacy of users of the endpoint device.

It should be noted that the methods described above may be implemented in a system comprising a hardware processor. Alternatively, the methods may be implemented using computer executable instructions of a non-transitory computer readable medium.

In some aspects, the techniques described herein relate to a system for detecting malicious activity using a foundational language model, including: at least one memory; at least one hardware processor coupled with the at least one memory and configured, individually or in combination, to: receive a plurality of logs indicative of software behavior from an endpoint device; generate, based on the plurality of logs, a provenance graph that represents relationships between different types of data objects on the endpoint device by linking a plurality of data objects by a plurality of actions; detect a plurality of trigger actions in the provenance graph; generate, for each respective trigger action of the plurality of trigger actions, a sequence of events that contributed to an occurrence of the respective trigger action based on the provenance graph; train, using sequences of events generated for the plurality of trigger actions, a foundational language model to predict resultant events for a sequence of lead up events and classify whether the resultant events indicate malicious activity; and detect the malicious activity by applying the foundational language model on an input sequence of events.

In some aspects, the techniques described herein relate to a non-transitory computer readable medium storing thereon computer executable instructions for detecting malicious activity using a foundational language model, including instructions for: receiving a plurality of logs indicative of software behavior from an endpoint device; generating, based on the plurality of logs, a provenance graph that represents relationships between different types of data objects on the endpoint device by linking a plurality of data objects by a plurality of actions; detecting a plurality of trigger actions in the provenance graph; generating, for each respective trigger action of the plurality of trigger actions, a sequence of events that contributed to an occurrence of the respective trigger action based on the provenance graph; training, using sequences of events generated for the plurality of trigger actions, a foundational language model to predict resultant events for a sequence of lead up events and classify whether the resultant events indicate malicious activity; and detecting the malicious activity by applying the foundational language model on an input sequence of events.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for detecting malicious activity with a foundational language model.

FIG. 2 is a diagram illustrating the generation of a sequence of events from a log.

FIG. 3 illustrates a flow diagram of a method for detecting malicious activity with a foundational language model.

FIG. 4 illustrates a flow diagram of a method for generating a provenance graph.

FIG. 5 illustrates a flow diagram of a method for generating a sequence of events.

FIG. 6 presents an example of a general-purpose computer system on which aspects of the present disclosure may be implemented.

### DETAILED DESCRIPTION

Exemplary aspects are described herein in the context of a system, method, and computer program product for detecting malicious activity with a foundational language model. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes a foundational language model developed using unsupervised training on a dataset (e.g., including log file information) of a large number of endpoint system users. The trained foundational language model may be used in endpoint systems for various security applications such as anomaly detection, insider attack detection, malware detection, investigation, etc.

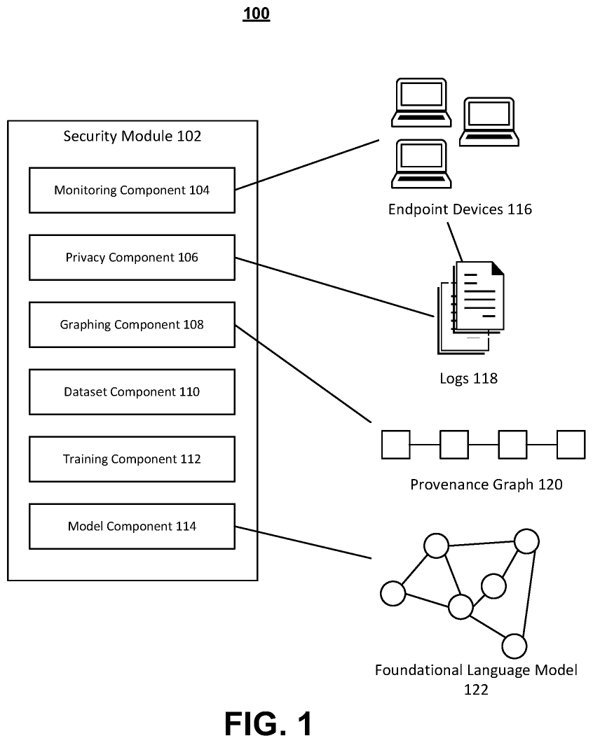

FIG. 1 is a block diagram illustrating system 100 for detecting malicious activity with a foundational language model. System 100 includes security module 102, which may be software part of an endpoint detection and response (EDR) system. Security module 102 includes multiple components including monitoring component 104, privacy component 106, graphing component 108, dataset component 110, training component 112, and model component 114. Monitoring component 104 is configured to monitor and log the behavior of applications on endpoint devices 116. For example, monitoring component 104 may collect logs 118 from endpoint devices 116. The monitoring by monitoring component 104 happens at a low level (e.g., tracking kernel API calls or operating system calls). The collection may be done through software (e.g., an agent) that is installed or built-in as part of the operating system of a given endpoint device. In some aspects, the collection may happen on virtual machines or on physical machines. In order to receive a diverse set of data, the collection may be done across multiple systems, from different users, companies, countries, industries, languages, and OS versions. The result generated by monitoring component 104 is logs 118, which may include system logs, process logs, behavior logs, etc.

Privacy component 106 is configured to remove all user identities from collected logs 118. For example, privacy component 106 may scan a log and remove personal identifiable information (PII), which may be used to identify a person. Examples of PII include, but are not limited to, name, date of birth, address, and government identifiers (e.g., social security number). In some aspects, privacy component 106 performs the removal of PII locally at a given endpoint device such that the PII does not leave the endpoint device.

Graphing component 108 may further create a provenance graph, which captures the relationship between different processes running at an endpoint device, using logs 118. For example, for a given endpoint device, graphing component 108 may generate provenance graph 120. Provenance graph 120 gives an ordered relationship between the different events occurring on the endpoint device (e.g., which process created which files, which IP address was contacted, which process executed a downloaded file, which files were downloaded, etc.).

In some aspects, graphing component 108 considers multiple types of events or actions. These events include, but are not limited to:
Process start: a new application is executed.
File system access: a file or folder is modified, written, deleted, or read.
Network connections: any access to the Internet with protocols such as TCP and UDP
Registry access (Windows™ system only): a registry key is written or read

Dataset component 110 is configured to generate a training dataset by generating multiple sequences of events from each provenance graph generated. In some aspects, the sequences from one graph may have overlapping events. In some aspects, all events originate from a common provenance graph and are sorted by timestamp. The training dataset is then used by training component 112 to train model component 114. Model component 114 specifically is a foundational language model 122.

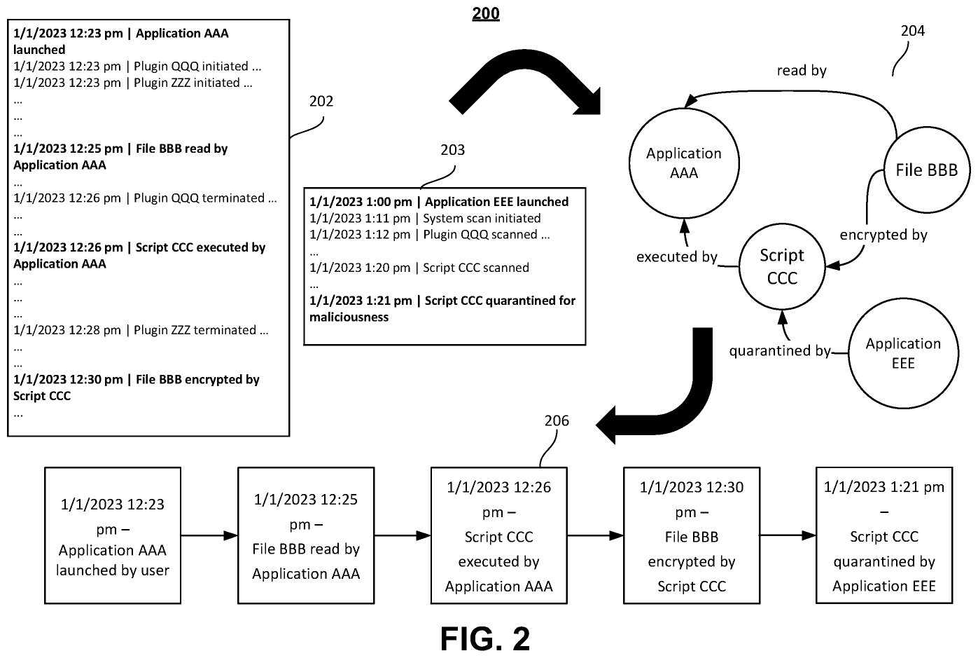

FIG. 2 is a diagram 200 illustrating the generation of a sequence of events 206 from a log. Suppose that application AAA is a web browser that downloads/executes a malicious script CCC, which encrypts file DDD on an endpoint device. Log 202 may be specific to a particular process/application (e.g., application AAA) and may capture this behavior. Although logs may include several fields indicating various identifiers, dependencies, timestamps, statuses, etc., log 202 is presented in a basic manner for simplicity. As can be seen, log 202 may include several events. Depending on the complexity of the processes running and the level of detail captured, log 202 may include several thousand entries. Creating a sequence of events from a log alone does not produce effective training sequences because there may be several filler events between noteworthy events. For example, in log 202, the events related to various plugins and other events not shown but indicated by “ . . . ” may not be influential from a security perspective.

Furthermore, multiple logs may be needed to identify a sequence. Alignment of the logs is non-trivial as each log includes different information. For example, log 203 may be associated with the execution of application EEE, which may be an anti-virus scanning application. After scanning multiple files, applications, etc., application EEE may determine that script CCC is malicious, and may quarantine/remove the script.

Graphing component 108 may generate provenance graph 204 using the information from logs 202 and 203. For example, graphing component 108 may identify objects such as files, scripts, applications, processes, etc. These objects are visualized in FIG. 2 by circular identifiers. Each object may be connected to another object by an action. For example, application AAA is connected to script CCC and the link is labeled “executed by.” Unlike logs 202 and 203, provenance graph 204 clearly highlights the relationships between the objects.

Dataset component 110 is configured to generate one or more sequence of events such as sequence 206 using both logs and the provenance graph. For example, dataset component 110 may identify certain events such as the quarantining event that indicates the presence of malicious activity on an endpoint device. Dataset component 110 may then identify, using the timestamps in the logs, and the links in provenance graphs, a list of events that contributed to the event(s) indicative of the presence of malicious activity. Referring to diagram 200, dataset component 110 may determine that the quarantined script CCC encrypted file BBB, and was executed by application AAA. Dataset component 110 may also determine that file BBB is normally read by application AAA. It is possible that without being able to read file BBB, application AAA may crash. In some aspects, dataset component 110 generates sequence 206 based on these relationships. In particular, any event that is directly related to an object (e.g., script CCC) associated with a trigger action (e.g., quarantining) is a candidate for inclusion in a sequence.

In some aspects, sequence 206 may be structured differently than the example shown in FIG. 2. For example, event types or actions such as “read,” “execute,” “encrypt,” etc., may be mapped to quantitative values such as 1, 2, 3, respectively. Accordingly, whenever a source object applies an action on a target object, the sequence may simply include a timestamp of the action, an identifier of the source object, an action value, and an identifier of the target object in an event. For example, “1/1/2023 12:25 pm—File BBB read by Application AAA” may be simplified to “1/1/2023/12:25/BBB/1/AAA.”

On a high level, foundational language model 122 learns the characteristics of applications and processes in endpoint devices 116 using information in the generated sequences. The model offers two advantages over the use of rules and traditional machine learning models: (1) the training dataset does not need to be manually labelled, (2) the model is highly effective in performing a plurality of downstream tasks such as malware detection, malware classification, malware signature generation, anomaly detection, misconfiguration detection, etc.

In one implementation, foundational language model 122 specifically uses sequences of events in a time-window to learn application behavior. The sequences, as extracted from provenance graphs, connect different events, such as file creations, processes executions, registry modifications, network communications, etc. For example, during training, training component 112 may mask N amount of events in a sequence, and foundational language model 122 may be trained to predict said masked events (e.g., predict the next event given a sequence of events). For example, given the first three events in sequence 206, foundational language model 122 is trained to predict the last two events.

In another implementation, dataset component 110 is configured to analyze a provenance graph and detect a set of features that are relevant from a security perspective or may be associated with suspicious behavior. These features are trigger actions and include, but are not limited to:
A file gets downloaded and later executed (dropped binary)
Persistence is created via registry key
Persistence is created via startup folder
Sensitive data (e.g., web browser credentials, crypto wallet data, etc.) is accessed
A PowerShell script is started with obfuscated or Base64-encoded parameters.
An executable is started from a temporary folder location
A DNS lookup is performed for a suspicious domain.
An upload greater than a threshold amount of data is performed

Foundational language model 122 may be trained, using this training dataset of features, to predict a subset of masked features that define an event for one or more events in a sequence. Given an event sequence S, foundational language model 122 may determine whether one of these features is identifiable and may determine whether the S is associated with malicious activity. In another example, given an event sequence S associated with a malicious application and K other event sequences, model 122 may predict which one sequence of the K sequences belongs to the same malicious application as the given event sequence S based on the identified features. In yet another example, given an event sequence S, the model may predict an application type (e.g., safe, malicious, etc.) associated with event sequence S.

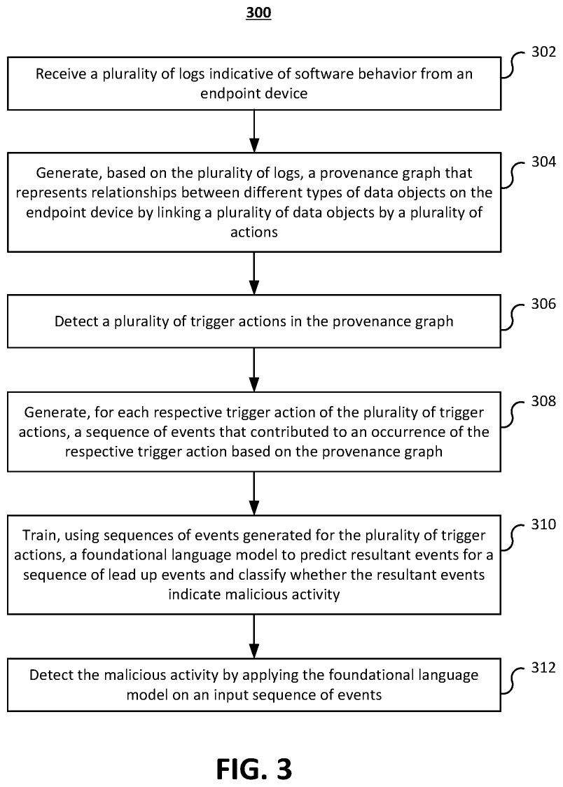

FIG. 3 illustrates a flow diagram of method 300 for detecting malicious activity with a foundational language model.

At 302, monitoring component 104 receives a plurality of logs (e.g., logs 202 and 203) indicative of software behavior from an endpoint device (e.g., one of endpoint device 116). In some aspects, monitoring component 104 may generate the logs by monitoring processes on the endpoint device using an agent locally installed on the endpoint device. In some aspects, monitoring the processes comprises tracking kernel API calls and/or operating system calls. In some aspects, privacy component 106 may remove personal identifiable information (PII) from the logs to maintain privacy of users of the endpoint device.

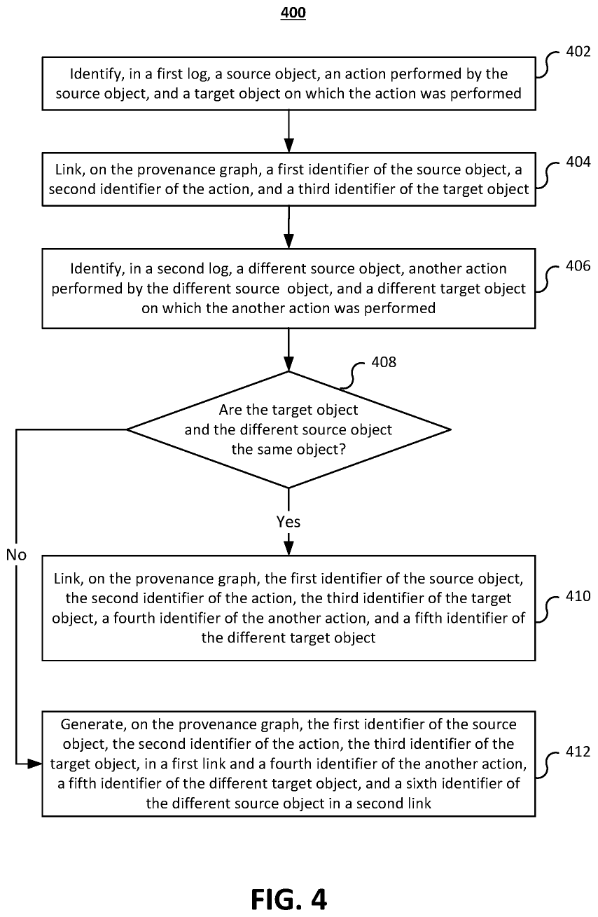

At 304, graphing component 108 generates, based on the plurality of logs, a provenance graph that represents relationships between different types of data objects on the endpoint device by linking a plurality of data objects by a plurality of actions. This generation step is described in detail in FIG. 4 (e.g., method 400 may be executed during step 304).

At 306, dataset component 110 detects a plurality of trigger actions in the provenance graph. In some aspects, the plurality of trigger actions is indicative of malicious activity. In some aspects, the plurality of trigger actions include one or more of: (a) a malicious file being detected, downloaded, or executed, (b) sensitive data being accessed, (c) an executable being started from a temporary folder location, (d) a DNS lookup is performed for a suspicious domain, (e) a PowerShell script being started with obfuscated parameters, (f) persistence being created via a registry key or via a startup folder, and (g) an upload size greater than a threshold data amount being performed.

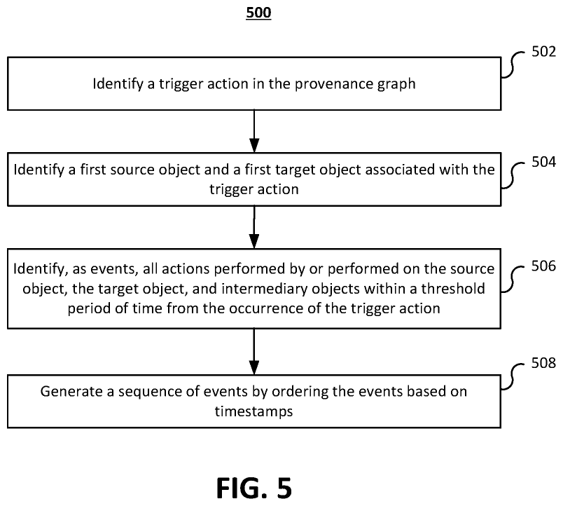

At 308, dataset component 110 generates, for each respective trigger action of the plurality of trigger actions, a sequence of events that contributed to an occurrence of the respective trigger action based on the provenance graph. In some aspects, the sequences of events comprise ordered events capturing one or more of: (a) a process initiating or terminating, (b) a file or directory being created, modified, deleted, or read, (c) a network connection being established, modified, or terminated, (d) a registry file being accessed. The generation of the sequences of events is further described in FIG. 5 (e.g., method 500 may be executed during step 308).

At 310, training component 112 trains, using sequences of events generated for the plurality of trigger actions, a foundational language model (e.g., model 122) to predict resultant events for a sequence of lead up events and classify whether the resultant events indicate malicious activity. In some aspects, wherein each respective sequence of the sequences of events comprises a first plurality of lead up events and a second plurality of resultant events. Accordingly, training the foundational language model comprises masking, for each respective sequence of the sequences of events, the second plurality of resultant events, and adjusting parameters (e.g., weights) of the foundational language model to output the second plurality of resultant events for an input comprising the first plurality of lead up events.

In some aspects, training component 112 may train foundational language model 122 to compare an input sequence with known sequences comprising malicious activity. For example, given an event sequence S associated with a malicious application and K other event sequences, model 122 may be trained to predict which one sequence of the K sequences belongs to the same malicious application as the given event sequence S based on the identified features. In another example, given an event sequence S, model 122 may be trained to may predict an application type (e.g., safe, malicious, etc.) associated with event sequence S. For example, each trigger action associated with malicious activity may be tagged with a particular label in the training dataset. Suppose that script CCC is quarantined. Accordingly, script CCC may be tagged with the label “malware.” This labelling is not manually performed, but rather retrieved from the results of a scan performed on script CCC by an anti-virus scanner. The same scanner may evaluate a different suspected data object and deem it to be “safe.” As a result, when trained, model 122 may be able to distinguish between malicious data objects and non-malicious data objects.

At 312, model component 114, including the trained model 122, is able to detect potential malicious activity by applying the foundational language model on any input sequence of events. For example, security module 102 may enter a testing phase for an application phase in which model 122 is fully trained. During this phase, security module 102 may receive logs, create/update a provenance graph based on the logs, and extract various sequences of events. These sequences of events serve as inputs to the trained model 122, which outputs the different information about the sequences. For example, if an input sequence of events is an ordered set of lead up events, security module 102 may generate a vector indicative of resultant events. Model 122 may further output an indication of whether the resultant events include malicious activity.

It should be noted that although method 300 describes receiving logs from one endpoint device, the method may be applied to multiple endpoint devices. For each endpoint device, at least one new provenance graph may be generated, from which sequences of events are extracted for training the single foundational language model. In fact, the diversity of the training dataset will improve the performance of the foundational language model.

FIG. 4 illustrates a flow diagram of method 400 for generating a provenance graph. At 402, graphing component 108 identifies, in a first log (e.g., log 203), a source object (e.g., application EEE), an action (e.g., “quarantined”) performed by the source object, and a target object (e.g., script CCC) on which the action was performed. At 404, graphing component 108 links, on the provenance graph (e.g., provenance graph 204), a first identifier of the source object (e.g., a name, a process ID, etc.), a second identifier of the action (e.g., text such as a name or number representing the action), and a third identifier of the target object. At 406, graphing component 108 identifies, in a second log (e.g., log 202), a different source object (e.g., script CCC), another action (e.g., encrypted) performed by the different source object, and a different target object (e.g., file BBB) on which the another action was performed. At 408, graphing component 108 determines whether the target object and the different source object are the same object. If they are the same object, method 400 advances to 410. If they are not the same object, method 400 advances to 412.

At 410, graphing component 108 links, on the provenance graph, the first identifier of the source object, the second identifier of the action, the third identifier of the target object, a fourth identifier of the another action, and a fifth identifier of the different target object. As shown in provenance graph 204, application EEE, script CCC, and file BBB are all linked by the actions “quarantined” and “encrypted.”

At 412, graphing component 108 generates, on the provenance graph, the first identifier of the source object, the second identifier of the action, the third identifier of the target object, in a first link and a fourth identifier of the another action, a fifth identifier of the different target object, and a sixth identifier of the different source object in a second link. In some aspects, the first link and the second link are not connected because the data objects are not directly connected.

FIG. 5 illustrates a flow diagram of method 500 for generating a sequence of events. At 502, dataset component 110 identifies a trigger action (e.g., “quarantined by”) in the provenance graph (e.g., provenance graph 204). At 504, dataset component 110 identifies a first source object (e.g., application EEE) and a first target object (e.g., script CCC) associated with the trigger action. At 506, dataset component 110 identifies, as events, all actions performed by or performed on the source object, the target object, and intermediary objects within a threshold period of time from the occurrence of the trigger action. For example, the threshold period of time may be 2 hours before and after the trigger action. The sequence of events may include the events directly related to script CCC, which was executed by application AAA and later encrypted file BBB. The intermediary objects are application AAA and file BBB. As shown in FIG. 2, application AAA reads file BBB. This event is also included in the sequence of events. At 508, dataset component 110 generates a sequence of events by ordering the events based on their timestamps.

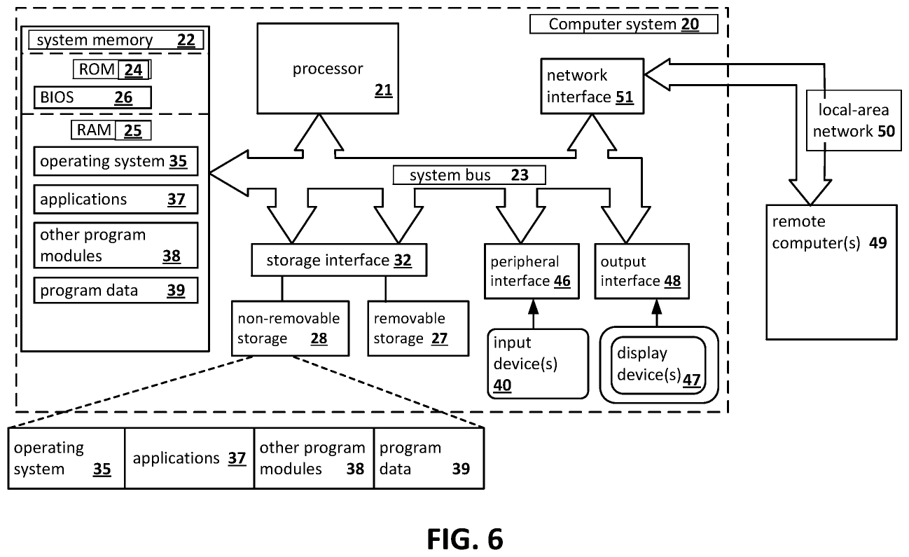

FIG. 6 is a block diagram illustrating a computer system 20 on which aspects of systems and methods for detecting malicious activity with a foundational language model may be implemented in accordance with an exemplary aspect. The computer system 20 may be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which may be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium may be a tangible device that can retain and store program code in the form of instructions or data structures that may be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein may be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure may be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for detecting malicious activity using a foundational language model, the method comprising:
receiving a plurality of logs indicative of software behavior from an endpoint device;
generating, based on the plurality of logs, a provenance graph that represents relationships between different types of data objects on the endpoint device by linking a plurality of data objects by a plurality of actions;
detecting a plurality of trigger actions in the provenance graph;
generating, for each respective trigger action of the plurality of trigger actions, a sequence of events that contributed to an occurrence of the respective trigger action based on the provenance graph;
training, using sequences of events generated for the plurality of trigger actions, a foundational language model to predict resultant events for a sequence of lead up events and classify whether the resultant events indicate malicious activity; and
detecting the malicious activity by applying the foundational language model on an input sequence of events.

2. The method of claim 1, wherein each respective sequence of the sequences of events comprises a first plurality of lead up events and a second plurality of resultant events, and wherein training the foundational language model comprises:
masking, for each respective sequence of the sequences of events, the second plurality of resultant events; and
adjusting parameters of the foundational language model to output the second plurality of resultant events for an input comprising the first plurality of lead up events.

3. The method of claim 1, wherein generating the provenance graph comprises:
identifying, in a first log, a source object, an action performed by the source object, and a target object on which the action was performed; and
linking, on the provenance graph, a first identifier of the source object, a second identifier of the action, and a third identifier of the target object.

4. The method of claim 3, wherein generating the provenance graph comprises:
identifying, in a second log, the target object, another action performed by the target object, and a different target object on which the another action was performed; and
linking, on the provenance graph, the first identifier of the source object, the second identifier of the action, the third identifier of the target object, a fourth identifier of the another action, and a fifth identifier of the different target object.

5. The method of claim 1, wherein the sequences of events comprise ordered events capturing one or more of: (a) a process initiating or terminating, (b) a file or directory being created, modified, deleted, or read, (c) a network connection being established, modified, or terminated, (d) a registry file being accessed.

6. The method of claim 1, wherein the plurality of trigger actions is indicative of malicious activity.

7. The method of claim 1, wherein the plurality of trigger actions comprise one or more of: (a) a malicious file being detected, downloaded, or executed, (b) sensitive data being accessed, (c) an executable being started from a temporary folder location, (d) a DNS lookup is performed for a suspicious domain, (e) a PowerShell script being started with obfuscated parameters, (f) persistence being created via a registry key or via a startup folder, and (g) an upload size greater than a threshold data amount being performed.

8. The method of claim 1, wherein receiving the plurality of logs comprises:
monitoring processes on the endpoint device using an agent locally installed on the endpoint device.

9. The method of claim 8, wherein monitoring the processes comprises tracking kernel API calls and/or operating system calls.

10. The method of claim 1, further comprising:
removing personal identifiable information (PII) from the logs to maintain privacy of users of the endpoint device.

11. A system for detecting malicious activity using a foundational language model, comprising:
at least one memory; and
at least one hardware processor coupled with the at least one memory and configured, individually or in combination, to:
receive a plurality of logs indicative of software behavior from an endpoint device;
generate, based on the plurality of logs, a provenance graph that represents relationships between different types of data objects on the endpoint device by linking a plurality of data objects by a plurality of actions;
detect a plurality of trigger actions in the provenance graph;
generate, for each respective trigger action of the plurality of trigger actions, a sequence of events that contributed to an occurrence of the respective trigger action based on the provenance graph;
train, using sequences of events generated for the plurality of trigger actions, a foundational language model to predict resultant events for a sequence of lead up events and classify whether the resultant events indicate malicious activity; and
detect the malicious activity by applying the foundational language model on an input sequence of events.

12. The system of claim 11, wherein each respective sequence of the sequences of events comprises a first plurality of lead up events and a second plurality of resultant events, and wherein the at least one hardware processor is configured to train the foundational language model by:
masking, for each respective sequence of the sequences of events, the second plurality of resultant events; and
adjusting parameters of the foundational language model to output the second plurality of resultant events for an input comprising the first plurality of lead up events.

13. The system of claim 11, wherein the at least one hardware processor is configured to generate the provenance graph by:
identifying, in a first log, a source object, an action performed by the source object, and a target object on which the action was performed; and
linking, on the provenance graph, a first identifier of the source object, a second identifier of the action, and a third identifier of the target object.

14. The system of claim 13, wherein the at least one hardware processor is configured to generate the provenance graph by:
identifying, in a second log, the target object, another action performed by the target object, and a different target object on which the another action was performed; and
linking, on the provenance graph, the first identifier of the source object, the second identifier of the action, the third identifier of the target object, a fourth identifier of the another action, and a fifth identifier of the different target object.

15. The system of claim 11, wherein the sequences of events comprise ordered events capturing one or more of: (a) a process initiating or terminating, (b) a file or directory being created, modified, deleted, or read, (c) a network connection being established, modified, or terminated, (d) a registry file being accessed.

16. The system of claim 11, wherein the plurality of trigger actions is indicative of malicious activity.

17. The system of claim 11, wherein the plurality of trigger actions comprise one or more of: (a) a malicious file being detected, downloaded, or executed, (b) sensitive data being accessed, (c) an executable being started from a temporary folder location, (d) a DNS lookup is performed for a suspicious domain, (e) a PowerShell script being started with obfuscated parameters, (f) persistence being created via a registry key or via a startup folder, and (g) an upload size greater than a threshold data amount being performed.

18. The system of claim 11, wherein the at least one hardware processor is configured to receive the plurality of logs by:
monitoring processes on the endpoint device using an agent locally installed on the endpoint device.

19. The system of claim 18, wherein monitoring the processes comprises tracking kernel API calls and/or operating system calls.

20. The system of claim 11, wherein the at least one hardware processor is configured to:
remove personal identifiable information (PII) from the logs to maintain privacy of users of the endpoint device.

21. A non-transitory computer readable medium storing thereon computer executable instructions for detecting malicious activity using a foundational language model, including instructions for:
receiving a plurality of logs indicative of software behavior from an endpoint device;
generating, based on the plurality of logs, a provenance graph that represents relationships between different types of data objects on the endpoint device by linking a plurality of data objects by a plurality of actions;
detecting a plurality of trigger actions in the provenance graph;
generating, for each respective trigger action of the plurality of trigger actions, a sequence of events that contributed to an occurrence of the respective trigger action based on the provenance graph;
training, using sequences of events generated for the plurality of trigger actions, a foundational language model to predict resultant events for a sequence of lead up events and classify whether the resultant events indicate malicious activity; and
detecting the malicious activity by applying the foundational language model on an input sequence of events.
